(19) United States
(12) Patent Application Publication
(10) Pub. No.: US 2002/0008939 A1
(43) Pub. Date: Jan. 24, 2002

(54) Pad design concepts for slider air-bearings

(76) Inventors: Zine Eddine Boutaghou, Vadnais Heights, MN (US); Anthony P. Sannino, Longmont, CO (US); Jason W. Riddering, Prior Lake, MN (US); Mary Cynthia Hipwell, Minneapolis, MN (US)

Correspondence Address: SCHWEGMAN, LUNDBERG, WOESSNER & KLUTH, P.A., P.O. BOX 2938, MINNEAPOLIS, MN, 55402, US

(21) Appl. No.: 09/833,746

(22) Filed: Apr. 12, 2001

Related U.S. Application Data
(60) Provisional application No. 60/196,746, filed on Apr. 12, 2000.

(51) Int. Cl. G11B 5/60

(52) U.S. Cl. 360/235.8; 360/236.1; 360/236.3

(57) ABSTRACT

A slider includes first and second trailing slider edges and side edges, and first and second rails disposed about the side edges. Each of the rails has a width measured from an inner rail edge to an outer rail edge, a leading air-bearing surface, and a trailing air-bearing surface. First and second convergent channels are recessed within the trailing air-bearing surfaces of the first and second rails, respectively. The slider further includes at least one raised bar extending across an air-bearing surface. The slider also includes raised features attached to the cavity or to the step level surfaces. Positional variations of features near the trailing edge are controlled more precisely by a step level mask which determines the position of the features and the trailing edge.

### RELATED APPLICATION

This application claims the benefit of U.S. Provisional Application Serial No. 60/196,746, filed Apr. 12, 2000 under 35 U.S.C. 119(e).

### FIELD OF THE INVENTION

The present invention relates to the field of mass storage devices. More particularly, this invention relates to sliders used in such devices.

### BACKGROUND OF THE INVENTION

One key component of any computer system is a device to store data. Computer systems have many different places where data can be stored. One common place for storing massive amounts of data in a computer system is on a disc drive. The most basic parts of a disc drive are an information storage disc that is rotated, an actuator that moves a transducer to various locations over the disc, and electrical circuitry that is used to write and read data to and from the disc. The disc drive also includes circuitry for encoding data so that it can be successfully retrieved and written to the disc surface. A microprocessor controls most of the operations of the disc drive as well as passing the data back to the requesting computer and taking data from a requesting computer for storing to the disc.

The transducer is typically placed on a small ceramic block, also referred to as a slider, that is aerodynamically designed so that it flies over the disc. The slider is passed over the disc in a transducing relationship with the disc. Most sliders have an air-bearing surface (ABS) which includes rails and a cavity between the rails. When the disc rotates (generally, at rotational speeds of 5,200 RPM or higher), air is dragged between the rails and the disc surface causing pressure, which forces the head away from the disc. At the same time, the air rushing past the cavity or depression in the air-bearing surface produces a negative pressure area. The negative pressure or suction counteracts the pressure produced at the rails. The slider is also attached to a load spring, which produces a force on the slider directed toward the disc surface. The various forces on the slider equilibrate, so that the slider flies over the surface of the disc at a particular desired fly height. The fly height is the distance between the disc surface and the transducing head, which is typically the thickness of the air lubrication film. This film eliminates the friction and resulting wear that would occur if the transducing head and disc were in mechanical contact during disc rotation. When a disc drive is turned off, most disc drives are designed to have one of two things occur. In some disc drives, the actuator removes the slider or flying portion of the disc drive from the disc, and in other disc drives, the actuator moves the slider to a parking area on the disc. The second type of disc drive is known as a comtact start/stop mainframe (“CSS”) drive. In a CSS drive, it is important that the slider lift off from the disc surface quickly. In addition, it is also important that measures be taken to eliminate or reduce a phenomenon known as stiction. However, stiction is caused by static friction and viscous shear forces, and causes the slider to stick to the disc surface after periods of non-use. The lubricant on the disc exasperates the stiction problem. The stiction can damage the head or the disc when the slider is freed from the disc surface. Additionally, the spindle motor used to rotate the disc must provide sufficient torque to overcome the stiction. Therefore, it is desired to limit the sticking friction (“stiction”) between the slider and the disc surface during the start and stop of disc rotation.

One technique used to overcome the problem associated with stiction, is to provide texturing to at least a portion (landing zone) of the disc surface, which reduces the contact area between the slider and the disc surface when the slider is at rest within the landing zone. However, this reduces the effective recording area of the disc. Additionally, as the flying heights are reduced to achieve higher recording densities, it becomes difficult to implement a textured landing zone since the height of the roughness peaks that is required to limit the stiction forces in the textured landing zone may be higher than the flying height of the slider. This difficulty has led to the use of head-disc interfaces in which the air-bearing surface of the slider includes texture or one or more discrete pads on the air-bearing surfaces. These pads provide small surface areas for contacting the disc surface without significantly affecting the bearing characteristics.

Improvements can be made to the discrete pads and more specifically to the placement of the discrete pads on the air-bearing surfaces of a slider. It should be noted that a slider or small ceramic block carrying a transducer, while flying, is tilted or pitched. In other words, just like an airplane wing or a water ski, the front or leading edge of the slider is tilted upward at a farther distance than the trailing edge or back edge of a wing or ski or slider. As a result, pads that are placed near to the trailing edge of the slider, generally have more effect on the flying characteristics of the slider. As a result, placement of the various features near the trailing edge of the slider is much more critical than placing the features near the leading edge of a slider. In order to assure that all the various manufactured sliders have approximately the same flying characteristics, it is critical to have very precise placement of the features near and at the trailing edge of the slider.

Therefore, what is needed is a process that allows for very precise placement of features with respect to the air bearing geometry. What is also needed is an improved pad design for the bearing surface of the slider that minimizes stiction with the disc surface during take-off from the disc surface, and at the same time meets the increasing demand to produce smaller and smaller head-disc spacing to improve read/write performances of disc drives.

### SUMMARY OF THE INVENTION

A slider includes a cavity dam, a subambient pressure cavity, and first and second elongated rails. The subambient pressure cavity trails the cavity dam and has a cavity floor. The first and second rails are disposed about the subambient pressure cavity. Each of the rails has a rail width measured from an inner rail edge to an outer rail edge, a leading bearing surface, a trailing bearing surface, and a recessed area extending between the leading and trailing bearing surfaces. The recessed area is recessed from the bearing surfaces and raised from the cavity floor, across the rail width. First and second convergent channels are recessed within the trailing bearing surfaces of the first and second rails, respectively. Each channel has a leading channel end open to fluid flow from the respective recessed area, non-divergent channel side walls, and a trailing channel end closed to the fluid flow and forward of a localized region of the respective trailing bearing surface. Each of the channels has a side wall on either side of the leading channel ends. The slider also includes a raised bar traversing each of the trailing bearing surfaces of the first and second rails such that the raised bar is near the leading channel end. The raised bar provides a separation between the bearing surfaces and a disc surface when the head slider is at rest on the disc surface. The raised bar is positioned on the trailing bearing surfaces such that it has a reduced impact on the overall flying characteristics of the head slider. In addition, the raised bar can be precisely positioned on the trailing bearing surface with respect to the trailing edge so that consistent flying characteristics are achieved in various manufactured sliders. Further, the bar separates the slider from the disc and significantly reduces stiction forces between the slider and the disc surface. In some embodiments, the raised bar is made of diamond-like carbon material (“DLC”).

Another aspect of the present invention relates to a disc slider, which includes a leading slider edge, a trailing slider edge, a cavity dam, and a subambient pressure cavity. The subambient pressure cavity trails the cavity dam and has a cavity floor. The first and second rails are disposed about the subambient pressure cavity. Each of the rails has a rail width measured from an inner rail edge to an outer rail edge, a leading bearing surface, a trailing bearing surface, and a recessed area extending between the leading and trailing bearing surfaces. The recessed area is recessed from the bearing surfaces and raised from the cavity floor, across the rail width. First and second convergent channels are recessed within the trailing bearing surfaces of the first and second rails, respectively. Each channel has a leading channel end open to fluid flow from the respective recessed area, non-divergent channel side walls and a trailing channel end closed to the fluid flow and forward of a localized region of the respective trailing bearing surface. The disc slider further has at least one raised pad positioned on each of the leading bearing surfaces of the first and second rails. The pads on the leading bearing surface are made of DLC. The slider also includes at least one raised pad positioned on each of the recessed areas of the first and second rails. The raised pads positioned on the recessed areas extend beyond the air-bearing surface of the slider to provide a separation between the bearing surfaces and a disc surface when the slider is at rest on the disc surface. The raised pads associated with the recess include a cap of DLC or wear-enhancing material. The raised pad positioned on the recessed areas sit on a longer column than the pads on the leading bearing surfaces, which reduces surface tension between the slider and a lubricant disposed on a disc surface. Because of the increased effective height of the pad (longer column on which the raised pad is placed), the radius of curvature formed by the meniscus between the column and the disc surface is larger which accounts for the reduced surface tension. Reduced surface tension equates with reduced stiction. Furthermore, since the pad location is determined very precisely by the air-bearing mask, the pads produce consistent flying characteristics since positional variations in the raised pad with respect to the recessed areas are minimized.

The head slider further includes first and second convergent channels, which are recessed within the trailing bearing surfaces of the first and second rails, respectively. Each of the first and second channels has a leading channel end open to fluid flow from the respective recessed area, non-divergent channel side walls, and a trailing channel end closed to the fluid flow and forward of a localized region of the respective trailing bearing surface. Each of the first and second channels further has a side wall on either side of the leading channel ends.

The slider further includes a raised center rail positioned along the trailing slider edge and between the first and second elongated raised side rails. The raised center rail has a leading step surface. The leading step surface is substantially parallel to and recessed from a center rail bearing surface. The center rail bearing surface is at a height similar to the height of the leading and trailing bearing surfaces. In fact, the center rail bearing surface, the leading bearing surfaces and the trailing bearing surfaces form what is commonly known as the air-bearing surface of the slider. The recess between the leading bearing surface and the trailing bearing surface on each side rail, as well as the step surface in front of the raised center rail bearing surface, are all on a similar level known as the step level. Finally, the cavity is at its own level with respect to the air-bearing surface of the slider. In some embodiments, pads may be placed or positioned on the cavity which extend to a position beyond the air-bearing surface of the slider. These pads are known as pedestals and there can be one or more of these pedestals positioned in the cavity. These pads can also be very precisely positioned since their position is determined by the air-bearing mask. The pads within the cavity are on relatively long columns and, therefore, are referred to as pedestals. The pedestals are capped with a wear-resistant material such as DLC.

Yet another aspect of the present invention relates to a disc drive assembly, which includes a housing, a disc, an actuator and a slider. The disc is rotatable about a central axis within the housing and has a recording surface with a data area and a landing area, which are non-textured. The actuator is mounted within the housing. The slider is supported over the recording surface by the actuator and includes a cavity dam, a subambient pressure cavity and first and second elongated rails. The subambient pressure cavity trails the cavity dam and has a cavity floor. The first and second rails are disposed about the subambient pressure cavity. Each of the rails has a rail width measured from an inner rail edge to an outer rail edge, a leading bearing surface, a trailing bearing surface, and a recessed area extending between the leading and trailing bearing surfaces. The recessed area is recessed from the bearing surfaces and raised from the cavity floor, across the rail width. The slider further includes a raised center rail with a leading step surface. The leading step surface is parallel to and recessed from a center rail bearing surface. The center rail step surface is at a height similar to the height of the recess on each rail. The center rail step includes one or more pads. The pads are capped with DLC or another long-wearing material. The placement of these center rail step pads can be carefully and precisely controlled with the air-bearing mask to produce consistent flying characteristics.

Advantageously, the improved slider designs described above reduce variations in the flying characteristics of the slider due to placement variations in placement of the raised bars and raised pads near the trailing edge of the slider. This improves read/write performance of the disc drives while lessening stiction problems.

### BRIEF DESCRIPTION OF THE DRAWINGS

FIG. 1 is an exploded view of a disc drive with a multiple disc stack.

FIG. 2 is a perspective view of one embodiment of a slider shown in FIG. 1, according to the teachings of the present invention.

FIG. 3 is a perspective view of another embodiment of a slider shown in FIG. 2, according to the teachings of the present invention.

FIG. 4 illustrates radius of curvature of the meniscus formed on pads.

FIG. 5 is a perspective view of another embodiment of a slider shown in FIG. 3, according to the teachings of the present invention.

FIG. 6 is a perspective view of another embodiment of a slider shown in FIG. 5, according to the teachings of the present invention.

FIG. 7 is a schematic view of a computer system.

FIG. 8 is a perspective view of another embodiment of a slider according to the teachings of the present invention.

FIG. 9 is a perspective view of yet another embodiment of a slider according to the teachings of the present invention.

FIG. 10 is a perspective view of another embodiment of a slider according to the teachings of the present invention.

FIG. 11 is a perspective view of another embodiment of a slider according to the teachings of the present invention.

FIG. 12 is a perspective view of another embodiment of a slider according to the teachings of the present invention.

FIG. 13 is a perspective view of yet another embodiment of a slider according to the teachings of this invention.

FIG. 14 is a perspective view of another embodiment of a slider according to the teachings of this invention.

### DESCRIPTION OF THE PREFERRED EMBODIMENTS

In the following detailed description of the preferred embodiments, reference is made to the accompanying drawings, which form a part hereof, and in which are shown by way of illustration specific embodiments in which the invention may be practiced. It is to be understood that other embodiments may be utilized and structural changes may be made without departing from the scope of the present invention.

The invention described in this application is useful with all mechanical configurations of disc drives having either rotary or linear actuation. In addition, the invention is also useful in all types of disc drives including hard disc drives, zip drives, floppy disc drives and any other type of drives where unloading the transducer from a surface and parking the transducer may be desirable.

The terms “slider,” “disc head slider,” and “head slider” are used interchangeably throughout this document.

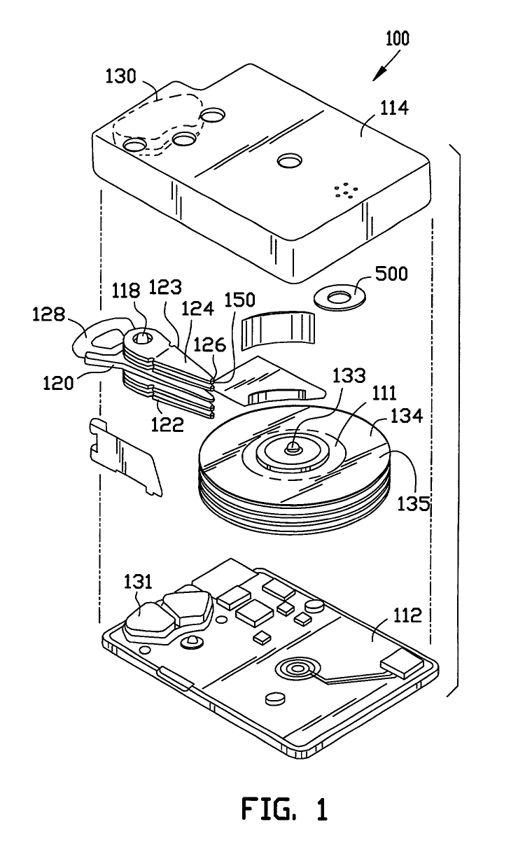

FIG. 1 is an exploded view of one type of disc drive 100 having a rotary actuator. The disc drive 100 includes a housing or a base 112, and a cover 114. The base 112 and cover 114 form a disc enclosure. An inertia ring 500 is attached to the cover 114. Rotatably attached to the base 112 on an actuator shaft 118 is an actuator assembly 120. The actuator assembly 120 includes a comb-like structure 122 having a plurality of arms 123. Attached to the separate arms 123 on the comb 122, are load beams or load springs 124. Load beams or load springs are also referred to as suspensions. Attached at the end of each load spring 124 is a slider 126, which carries a magnetic transducer 150. The slider 126 with the transducer 150 form the head. It should be noted that many sliders have one transducer 150 and as is shown in the figures. It should also be noted that this invention is equally applicable to sliders having more than one transducer, such as an MR or magneto resistive head in which one transducer 150 is generally used for reading and another is generally used for writing. On the end of the actuator arm assembly 120, opposite the load springs 124 and the sliders 126, is a voice coil 128.

Attached within the base 112 is a first magnet 130 and a second magnet 131. As shown in FIG. 1, the second magnet 131 is associated with the cover 114. The first and second magnets 130, 131 and the voice coil 128 are the key components of a voice coil motor, which applies a force to the actuator assembly 120 to rotate it about the actuator shaft 118. Also mounted to the base 112 is a spindle motor. The spindle motor includes a rotating portion called the spindle hub 133. In this particular disc drive, the spindle motor is within the hub. In FIG. 1, a number of discs 134 are attached to the spindle hub 133. Each of the discs 134 has a recording surface 135. Only one disc 134 is numbered for the sake of clarity. In other disc drives a single disc or a different number of discs may be attached to the hub. The invention described herein is equally applicable to disc drives which have a plurality of discs as well as disc drives that have a single disc. The invention described herein is also equally applicable to disc drives with spindle motors, which are within the hub 133 or under the hub.

As discussed in more detail below, slider 126 forms a hydrodynamic bearing, when flying or moving over the disc surface 135. The air-bearing surfaces generate discrete areas of localized pressure while the slider flies over the disc surface 135. When non-operational or when the slider is parked over a landing area, various features of the slider 126 prevent meniscus formation of disc lubricant and reduce contact area between the slider and the disc. These features allow discs 134 to be fabricated with a smooth or less-textured slider landing zone 111, without causing unreasonably high stiction forces between the slider and the disc surface.

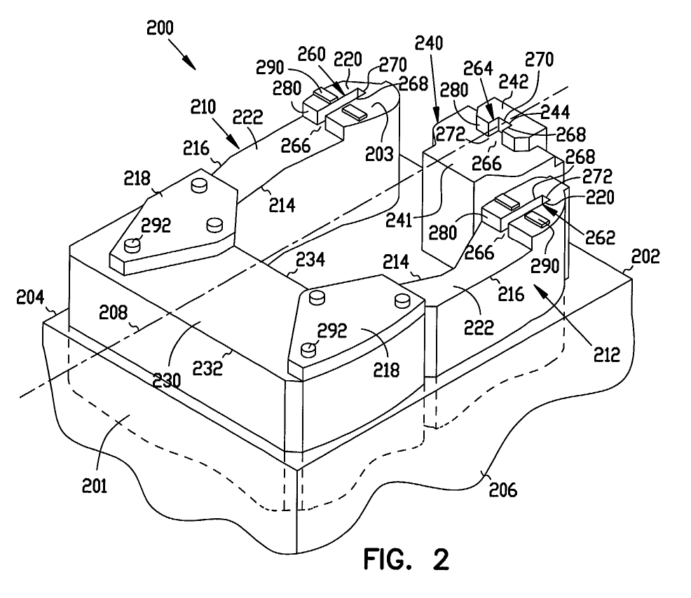

Referring now to FIG. 2, there is shown a perspective view 200 of one embodiment the slider 126 of FIG. 1. FIG. 2 shows the air-bearing surface 203 of the slider 200. It should be noted that the vertical dimension of all the figures that show the air bearing surface is exaggerated for the sake of illustrating the concepts of the invention. In other words, the vertical dimension of the air bearing surface is exaggerated in FIGS. 2-6 and 8-13. Returning to FIG. 2, the air-bearing surface 203 is the surface confronting the discs 134 when the slider 200 is flying or passing over the surface 135 of the disc 134 during normal operation. The slider 200 has a leading edge 201, a trailing edge 202, side edges 204 and 206, and a lateral center line 208. Elongated, raised side rails 210 and 212 are positioned along side edges 204 and 206, respectively. Rails 210 and 212 extend generally from leading edge 201 toward trailing edge 202 and terminate prior to trailing edge 202. Each rail 210 and 212 has an inside rail edge 214, an outside rail edge 216, a leading air-bearing surface 218, a trailing air-bearing surface 220 and a recessed waist portion 222. Recessed waist portion 222 extends from leading air-bearing surface 218 to trailing air-bearing surface 220. In some embodiments, the waist portion is generally parallel to and recessed from each leading air-bearing surface 218 and each trailing air-bearing surface 220 by a step having a depth of about 0.1 to 0.5 micrometers. Of course, other depths can also be used in other embodiments. The recessed portions are generally considered to be at a step level along with several other elements of the slider 200. The recessed waist portions reduce the contact area of the slider 126 when at rest on the surface 135 of the disc 134 or during inadvertent contact with the disc. The recessed waist portions also develop substantially ambient pressure during flight.

A cavity dam 230 extends between rails 210 and 212, along leading edge 201. Cavity dam 230 has a leading edge 232 and a trailing edge 234. Cavity dam 230 and side rails 210 and 212 define a subambient pressure cavity 236, which trails cavity dam 230 relative to a direction of air flow from the leading edge 201 toward trailing edge 202. A subambient pressure cavity 236 is recessed from leading and trailing air-bearing surfaces 218 and 220 as well as those surfaces at the step level. The cavity floor is at the cavity level. Generally the surface of the waist portion 222 of each side rail 210, 212 is recessed from bearing surfaces 218 and 220. Waist portions 222 remain raised from the floor of the cavity 236 such that the waist portions 222 continue to define the shape of the cavity 236 and contain subambient pressure within the cavity 236. In other words, the surface of the waist portion 222 of each side rail 210, 212 is at the step level between the floor of cavity 236 and the surface defined by bearing surfaces 218, 220. The surface of the cavity dam 230 is also at the step level.

In some embodiments, the cavity dam 230 is generally parallel to and recessed from bearing surfaces 218 and 220 by a step depth of 0.1 to 0.5 micrometers, for example. Other depths can also be used. In addition, cavity dam 230 can be formed with a tapered leading edge in alternative embodiments, if desired.

A raised center pad or rail 240 is positioned along the trailing slider edge 202 and can be centered along the lateral center line 208. In some embodiments, the center pad 240 can be skewed or offset with respect to the line 208. The center pad 240 has a leading surface 241 at the step level, and an air-bearing surface 242. The leading surface is at the step level as are the recesses in the side rails and the cavity dam 230. Leading step surface 241 is generally parallel to and recessed from the bearing surface 242 by a step depth of 0.1 to 0.5 micrometers, for example, for providing pressurization of the bearing surface 242 from air flow venting from the cavity 236. The center pad 140 supports a read/write transducer 244 near the trailing slider edge 202 of the slider 200. In some embodiments, transducer 244 can be positioned at other locations on slider 126. However when placed at or near the trailing slider edge 202, transducer 244 is located at the closest point on slider 126 to the surface 135 of disc 134 when the slider is flying or passed over the disc 134. When the leading edge 201 flies slightly higher than the trailing edge 202 of the slider 200, the slider is said to fly at a positive pitch angle. When the slider 200 flies with a positive pitch angle, the trailing slider edge 202 is closer to the surface 135 of the disc 134 than the leading slider edge 201 and the transducer 244 is closely spaced with respect to the disc 134.

Rails 210 and 212 terminate prior to the trailing slider edge 202 to allow the slider 110 to roll slightly about the lateral center line 208 and minimize the risk of contact between the trailing rail edges 224 and the disc surface 134. Therefore, the trailing edge of center pad 240 remains the closest location on the slider 126 to the disc surface 135 during flight at various roll angles, thereby improving read and write performance. However, truncating the side rails 210 and 212 reduces the amount of positive pressure developed along the rails near the trailing slider edge 202, which in turn, reduces pitch and roll stiffness.

In order to limit the reduction in pitch and roll stiffness, in some embodiments the slider 126 further includes convergent channel features 260, 262, and 264, which are recessed within trailing air-bearing surfaces 220 of the side rails 210 and 212 and within the air-bearing surface 242 of the center rail 240. These channels are also referred to as trenches. Channels 260, 262, and 264 each have a leading channel end 266, non-divergent side walls 268, a trailing channel end 270, and a channel floor (a “step surface” which actually is at the step level) 272. In the embodiments shown, the channel floors 272 of channels 260 and 262 are coplanar and contiguous with recessed waist portions 222 of rails 210 and 212, while channel floor 272 of channel 264 is coplanar and contiguous with leading step surface 241 of the center rail 240. In other embodiments, the channel floors 272 and waist portions 222 may be at different levels.

In channels 260 and 262, the leading channel end 266 is open to fluid flow from recessed areas 222 of the side rails 210 and 212, respectively. However, the trailing channel end 270 is closed to the fluid flow. A portion of the fluid flow from the recessed areas 222 is directed into the channels 260 and 262 and is forced to exit the channels over the trailing channel ends 270. This creates localized positive pressure areas on the trailing bearing surfaces 220 at and near the trailing channel ends 270. In some embodiments, the trailing bearing surfaces 220 have a length measured from the trailing channel ends 270 to the trailing rail edges 224 that is equal to or greater than the width of the channels 260 and 262, as measured between side walls 268. This provides sufficient bearing surface on which the localized positive pressure can act. The localized positive pressure developed on the trailing air-bearing surfaces 220 increases the roll stiffness of the slider 126. The localized positive pressure also prevents or lessens the chance of inadvertent contact between the slider and the disc 134. The localized pressure also increases the pitch stiffness. The center pad 240 includes a similar feature.

With respect to the channel 264 on the center rail 240, the leading end 266 of this channel is open to fluid flow from the cavity 236, and the trailing channel end 270 is closed to the fluid flow. A portion of the fluid flow from cavity 236 is directed into the channel 264 and is forced to exit the channel over the trailing channel end 270. Again, this creates a localized positive pressure area on the air-bearing surface 242, rearward of the trailing channel end 270. In some embodiments, the center rail air-bearing surface 242 has a length between trailing channel end 270 and the trailing slider edge 202 that is at least the width of the channel 264, as measured between the side walls 268. The localized positive pressure developed on center rail air-bearing surface 242 increases the pitch stiffness of the slider 126.

During operation, the side walls 268 to either side of leading channel ends 266 present themselves as a substantial pressure rise to the local fluid flow. Since the opening to each channel, at the leading channel ends 266, does not have the same pressure rise, it is seen as a preferential path for the fluid flow to travel. Once the fluid flow enters the channels 260, 262, and 264, the flow is essentially bounded by the channel side walls 268 and trailing channel end 270 and is forced to rise over trailing channel end 270. This creates localized pressure areas at discrete regions near trailing slider edge 202. Channels 260, 262, and 264 can be symmetrical about the lateral center line 208, as shown in FIG. 1, or can be asymmetrical to provide preferential pressurization at certain slider skew angles.

The size and intensity of the localized positive pressure areas depend on the channel length-to-width ratio, the absolute sizes of the channels and the depth and shape of the channel floors. In some embodiments, the ratio of the channel lengths to the channel widths range from 0.5 to 5.0 micrometers but may vary outside that range depending on the design purpose of the channel feature. In some embodiments, the length-to-width ratio ranges from 2.0 to 2.5.

Each of the leading air-bearing surfaces 218 includes at least one raised pad 292 protruding from the first and second rails 210 and 212. The raised pads 292 prevent or lessen stiction in contact start stop (“CSS”) disc drives. Generally, the raised pad 292 has a surface area that has little or no effect on the overall flying characteristics of the head slider 200. The at least one raised pad 292 provides a separation between the leading air-bearing surfaces 218 and the disc surface 135 to significantly reduce stiction forces between the disc surface 135 and the slider 126. In some embodiments, the raised pads 292 extend from the air-bearing surfaces 218 in the range of about 5-70 nanometers and preferably in the range of 10-30 nanometers. The raised pads 292 associated with the leading air-bearing surfaces 218 are made of DLC material or another high-wear material.

It should be noted that the raised pads 292 associated with the leading air-bearing surface 218 are positioned toward the leading edge of the slider 200. Since the slider 200 flies in a pitched relationship where the leading edge is higher than the trailing edge, the raised pads 292 associated with the leading air-bearing surface 218 have little effect on the flying characteristics of the slider 200. Features which are closer to the trailing edge of the slider 200 or of any slider for that matter, generally affect the flying characteristics of the slider more than those near the leading edge of the slider.

Slider 126 further includes two raised bars 290. Each of the trailing bearing surfaces 220 includes a raised bar 290 that extends slightly from the surface of the trailing air-bearing surface. The raised bar 290 is disposed near the side walls 280. In some embodiments, the raised bars 290 extend from the trailing bearing surfaces 220 approximately in the range of about 5 to 70 nanometers. The raised bars 290 serve the same purposes as the raised pads 292 in a CSS drive, namely to provide a separation between the trailing edge air-bearing surfaces 220 and the disc surface 135 when the slider 126 is at rest on the disc surface 135. Since the raised bars 290 are more closely located near the trailing edge of the slider 200, they have more impact on the overall flying characteristics of the slider. The positional variations of the bar 290 are carefully controlled to minimize changes to the flying characteristics. The raised bar 290 is much less susceptible to variation in flying characteristics because of the width of the bar 290. The bar 290 is less dependent on pad mask placement when compared to individual pads. Generally, the flying characteristics of the slider depend on the position of pads and the bars on the slider 200. Therefore, it becomes critical to design the slider including the pads and the bars to be less sensitive to such positional variations on the slider 200. The raised bar 290 is formed of DLC or another wear-enhancing material.

The separation produced by bars 290 between the trailing edge air-bearing pads and the surface of the disc 134 significantly reduces the stiction forces between the slider 126 and the disc surface 134. The bar 290 is less sensitive to the positional variations than individual raised statures. Each raised bar 290 can extend generally from the outer rail edges 216 to the inner side walls 268. Each raised bar 290 can be parallel to the side walls 280. Each raised bar 290 can be of the same length as the side walls 280. In some embodiments, the raised bar 290 has a width in the range of about 5 to 100 micrometers. The width of each raised bar 290 generally runs from the leading edge 201 toward the trailing edge 202. The raised bar 290 can have cross sections in the shape of a square, or a rectangle. The cross section of the at least one raised bar 290 can be from the outer rail edge 216 toward the inner rail edge 214. The raised bar 290 is similar to the raised pads 292 in its functionality in reducing the stiction between the slider 126 and the disc surface 135. If several raised pads were used to replace the bar 290, the flying characteristics of a slider would be more sensitive to variation in the placement of raised pads on a trailing air-bearing surface. The advantage of one raised bar 290 is that there is no variation in position across the bar, unlike the placement of one or more raised pads (not shown in FIG. 2) on the trailing bearing surfaces 220. Raised pads would be sensitive in the width direction. Using the raised bar 290 instead of raised pads reduces the sensitivity to overall flying characteristics and significantly improves the design performance of the slider. The location of the raised bar 290 is less likely to significantly change the flying characteristics of the slider 200. During manufacture, the raised bars are made from diamond-like carbon material or other high-wear material on the surface associated with the air bearing. Bar 290 is less likely to significantly change the flying characteristics of the slider. A further advantage of the bar 290 is that it can be placed onto the air-bearing surface with lots of variation in respect to the width of where the bar is positioned. In other words, the position of the bar with respect to the trailing edge of the slider 200 needs to be very precisely positioned. However, the actual width dimension across or transverse to the side rails need not be carefully positioned. During manufacture, a diamond-like carbon bar that is overly wide will be placed onto the slider using a first mask for features which will be on air-bearing surfaces of the slider. Several other masks will be used to define the cavity and its shape and depth as well as the recesses and all the features placed on or at the step level of the slider 200. These other two masks are used to control etching processes such as reactive ion etching or ion milling or acid etching, each of which are used to remove material from unmasked portions of the ceramic slider. The placement of these masks for the etching is very, very precise so that if the width of the raised bar 290 is overly wide, subsequent masks used to etch away material and form the final slider geometry can be very precisely placed so that any over-wide portion is merely removed by a subsequent etching process. The final result is a very carefully placed raised bar 290 which has very consistent effects on the flying characteristics of the slider and also which has very low variation in terms of the effects on the flyability.

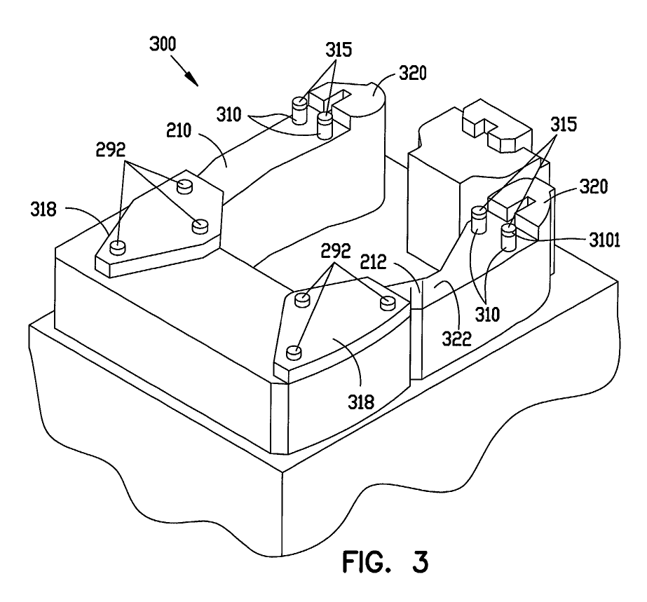

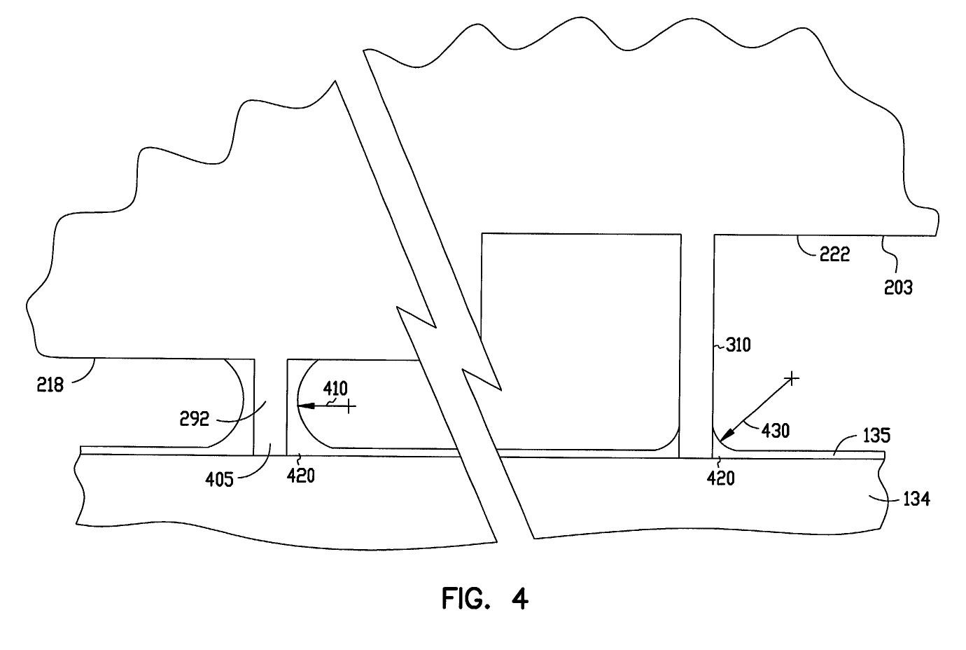

Referring now to FIG. 3, there is shown a perspective view 300 of another embodiment of a slider 300. The slider 300 shown in FIG. 3 is very similar to the slider 200 shown in FIG. 2, except that the trailing air-bearing surface 320 of slider 300 does not include a raised bar. Instead, the slider 300 includes at least one raised pad 310 extending from each of the recessed areas 322 of the first and second rails 210 and 212. As shown in FIG. 3 each side rail 210, 212 includes a pair of raised pads 310. The raised pads 310 are positioned on the side rail 210, 212 between the trailing air-bearing surface 320 and the leading air-bearing surface 318. The raised pads 310 provide a separation between the trailing bearing surfaces 220 and a disc surface 135 when the slider 300 is at rest on the disc surface 135. The raised pads 310 extend from the recessed areas 222 such that the extension reduces surface tension between a lubricant disposed on a disc surface 135 and the disc 134. The raised pads 310 are on longer columns than the raised pads 292. Therefore, when a meniscus is formed between the pads 310 having a very long column or sitting on a longer column than the raised pads 292, the raise of curvature of the lubricant formed by the meniscus is a larger radius than a shorter pad. This reduces the stiction forces between the slider 300 and the disc surface 134 and is further explained below with respect to FIG. 4. The raised pads 310 extend to substantially the same heights as the raised pads 292 on the leading edge bearing surface 318. Each of the pads 310 is capped with diamond-like carbon (“DLC”) and shown by reference numeral 3101. The DLC provides for a high wear surface in a CSS disc drive. As mentioned previously, the pads 292 are made of DLC.

The raised pads 310 associated with the recessed areas 222 of the first and second rails 210 and 212, are positioned on longer columns of material than the pads 292. The longer the column on which a pad 292, 310 sits, determines the effective height. In other words, the effective height of the raised pads 310 is higher than the raised pads 292 even though the free end of the pad 292, 310 is at the same height with respect to the recessed area 222. The inclusion of raised pads 310 considerably reduces dwell stiction between the disc surface 135 and the slider bearing surfaces 218 and 222 because the longer column associated with the raised pads 310 increase the radius of curvature of the meniscus formed by the lubricant on the disc surface 135 and the column of the raised pads 310. Increasing the radius of the curvature of the meniscus further reduces surface tension. Also, the raised pads 310 with an effective height higher than the raised pads 292 prevent formation of a second radius between the attachment point of the raised pads 310 and the level of the slider 300. Therefore, slider 300 has a reduced stiction force when compared to the slider shown in FIG. 2. In the embodiment shown in FIG. 3 there are two raised pads on each of the recessed areas 222. The raised pads 310 are disposed on the recessed areas 222 such that the raised pads 310 are closer to the side walls 280. The raised pads 310 are also symmetrical about the leading channel ends 266. Other configurations of raised pads are contemplated. The advantage of this configuration is that the raised pads 310 and the rails 210, 212 can both be formed at the same time. A step level mask is placed on the ceramic block to form the recessed areas 222, the cavity dam 230 and the step surface or leading surface 241 associated with the center pad. The step level mask is very carefully controlled which minimizes variations in the location of the raised pads 310 with respect to the rails 210 and 212. In fact, the rails 210 and 212 and the raised pads 310, the recessed areas 222, the cavity dam 230 and the leading surface 241 are all formed using the step level mask and this prevents variation in location of the raised pads 312 with respect to other elements of the slider since all these elements are formed by the same mask. Initially, the slider is provided with deposits of DLC in the general vicinity of the raised pads 310. The DLC is laid down initially on the air-bearing surface of the slider. Basically, a relatively large patch of DLC is placed onto the slider. The large patch of DLC encompasses all the various tolerances with which the step level mask can be placed onto the ceramic block. In other words, a large enough patch of DLC is laid down so that despite where the step level mask is positioned, given the tolerance it has, a raised pad 310 may be formed having a cap of DLC. This considerably simplifies the manufacturing process because the physical location of the DLC portion of the raised pads 310 on the recessed areas 222 can have a wider tolerance with respect to the rails 210 and 212. This also eliminates any fly height sigma addition due to placement of raised pads 310 on the recessed areas 222.

FIG. 4 shows a disc 134 having a disc surface 135 and slider 126 resting on the disc surface 135. The slider 126 includes a leading edge bearing surface 218 having a pad 292 and a recessed surface 222 with a raised pad 310. The column length of the raised pad 310 is larger than the column length of the raised pad 292. The surface 35 of the disc 134 is covered with a thin layer of lubricant 420.

FIG. 4 shows the difference in the formation of meniscus by the lubricant 420 disposed on the disc surface 135 between the pad 292 and the pad 310 and the disc surface 135. It can be seen from FIG. 4 that the shorter pad 292 produces a decreased radius of curvature 410 in the meniscus due to a surface tension between the shorter raised pad 292 and the lubricant 420. On the raised pad 292, a meniscus 410 is formed between a surface of the disc 135, and at the leading air-bearing surface 218. The decreased radius of curvature 410 increases the surface tension between the pad 292 and the lubricant 420. Increased surface tension results in higher stiction force between the pad 292 and the disc surface 135. Also, shown in FIG. 4 is that a meniscus forms between the leading air-bearing surface 218 and the column 405.

A taller pad 310 (such as the one used in FIG. 3) produces an increased radius of curvature. Taller pad 310 also prevents the formation of another radius and meniscus between the surface 222 and the raised pad 310 (generally due to not having enough lubricant 420 on the disc surface 134). The stiction force for the taller pad is reduced by half when compared with stiction force developed between the shorter pad 405 and the lubricant 420. FIG. 4 shows the advantage of having a higher effective height. Essentially, by increasing the radius of curvature of the meniscus formed, the surface tension and stiction is minimized.

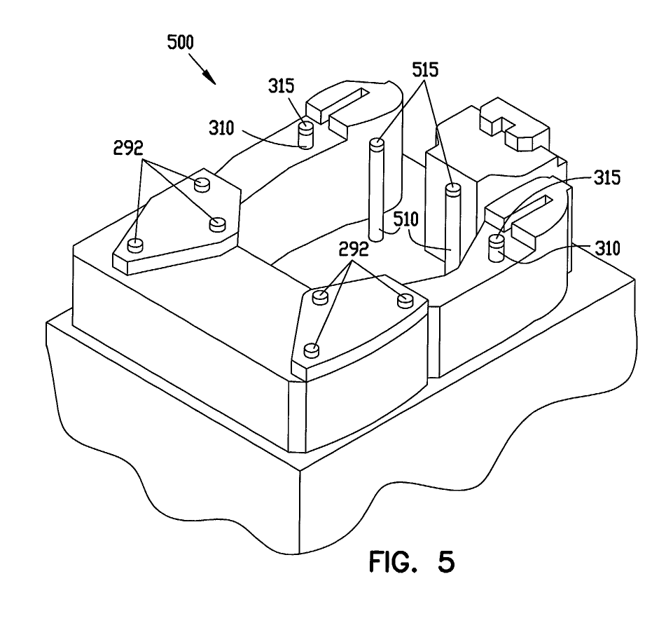

Referring now to FIG. 5, there is shown a perspective view of another embodiment of a slider 500. The slider 500 shown in FIG. 5 is very similar to the slider 300 shown in FIG. 3. The similar elements will not be discussed. The focus of the discussion will be on the differences. The slider 500 includes two raised pedestals or pads 510 extending from the floor of the subambient pressure cavity 236. In some embodiments, the slider 500 can have one or less than the two raised pedestals or pads 510 extending from the subambient pressure cavity 236. The two raised pads 510 are disposed proximate the raised center rail 240. The two raised pads 510 can be disposed symmetrically about the lateral center line 208. The pedestals 510 of slider 500 have many of the same advantages described above with reduced surface tension. In addition, the pedestals or raised pads 510 prevent stiction between the air-bearing surfaces and the disc surface 135. Reduced stiction improves the performance of the disc drive 100. The pedestals or raised pads 510 further include a layer of diamond-like carbon material 515 over the raised pads 510. Of course, the elongated column raised pads 510 could be arranged in various geometric configurations. The raised pads 510 could also be combined with the other raised pads 292, 310. The raised pads 510 or pedestals are also formed from the mask associated with the step surface and, therefore, can be precisely placed with respect to the trailing edge feature and other air-bearing features formed by the masking and etching processes used to form the geometry of the air-bearing surface. Like the pads 310, the pads 510 have a cap of diamond-like material. The diamond-like material forming the cap is initially placed on the air-bearing surface of the slider before etching or masking takes place. The DLC forming the top of the pedestal or raised pad 510 is placed across a wide area so that no matter what the tolerance of the step mask is, the top of the pedestal or top of the raised pad will always have diamond-like carbon or another wear-enhancing material at the top of the pedestal or top of the raised column. Once the steps have been formed, namely recesses 222, cavity dam 230, the air-bearing surface 242 of the center rail 240, and the channel floors 272 of the channels 264, these surfaces are then masked while etching is continued so that the ambient cavity can be formed on the slider. The step layer mask includes the pads 310 and 510. Certain portions of the slider, namely the step surfaces, are masked off and then the etching to remove the material will continue. In addition, the cavity level mask includes the features for the pedestals or raised pads 510 and these continue to stay in place throughout the etching process so that the end result will be a column or pedestal attached to the floor of the subambient cavity.

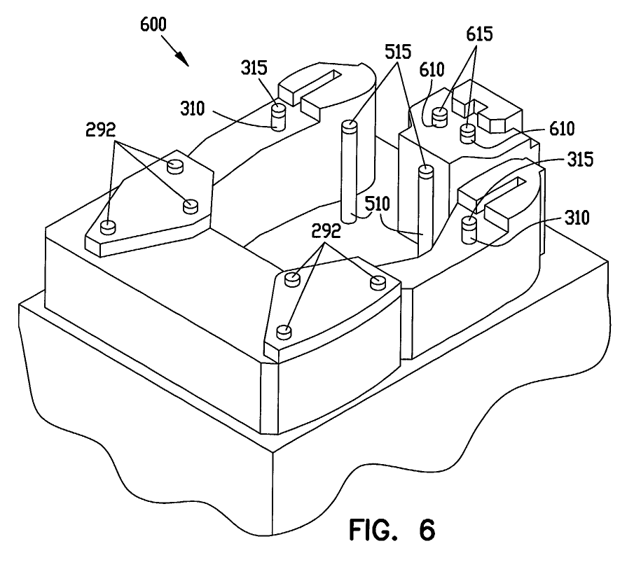

Referring now to FIG. 6, there is shown a perspective view of another embodiment of the slider 600. The slider 600 shown in FIG. 6 is very similar to the slider 500 shown in FIG. 5, except that in addition to what is shown in FIG. 5, the slider 600 includes two raised pads 610 on the leading step surface 241 of the center rail 240. In other embodiments, one raised pad 610 may be used. In other embodiments, a plurality of raised pads 610 may be useful. The configuration of the raised pads 610 may be changed to include other configurations than the configuration shown in which the two raised pads disposed closer to the side walls 280 of the channel 264 on the center rail 240. As shown, the two raised pads 610 are disposed symmetrically to the lateral center line 208. Raised pads 610 can be equal to or less than the height of the other pads disposed on the slider 600. Raised pads 610 are included to prevent center rail 240 from contacting the bearing surfaces 218 and 220 when parked or non-operational. The raised pads 610 prevent the center rail 240 of the slider 600 from contacting the disc 134. The raised pads 610 include a layer of diamond-like carbon material 615 over the raised pads 610.

The raised pads 610 are also formed using the step level mask so that the position of raised pads 610 with respect to the trailing edge and other step level mask features varies minimally. In addition, the DLC that ultimately forms the top cap of the raised pads 610 is placed using the step level mask so a less than accurate placement of DLC need be made. The DLC is placed so that it will be within tolerances of the step level mask.

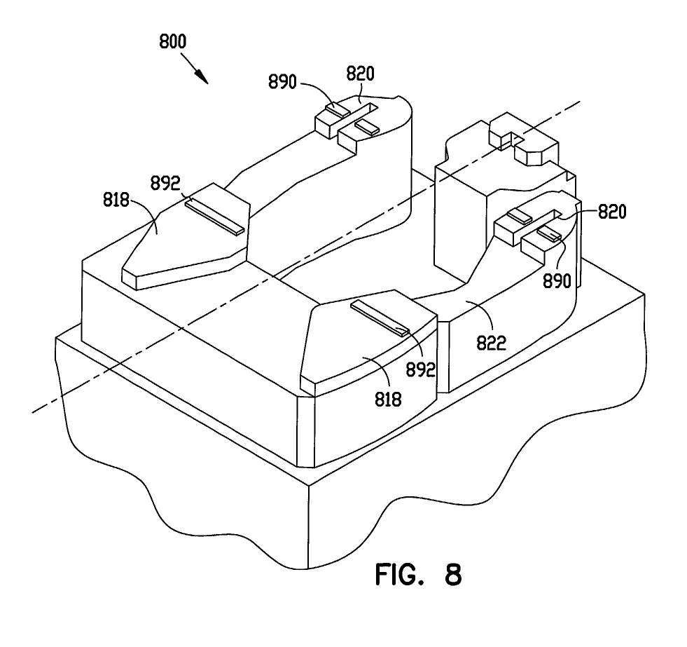

FIG. 8 shows yet another embodiment of a slider 800 that includes a set of raised bars which traverse a trench 862 on the trailing edge bearing surface 820. The trailing edge surfaces 820 appear to be pads upon each side rail 810 and 812 of the slider. A second set of raised bars 892 traverses each side rail in the area or on the leading edge bearing surface 818. The slider 800 includes a median line 808 about which the air-bearing surface 803 of the slider is symmetrical. Each of the raised bars 890, 892 are on lines which traverse the median line 808 of the slider 800. It should be noted that, as shown, the raised bars are on lines which are substantially perpendicular to the median line 808. The lines formed by the raised bars merely have to traverse the median line and could be at angles other than a perpendicular angle. In addition, the bars which traverse the median line could have different spacings. In other words, on the leading air-bearing surface 818 there could be a set of two closely spaced bars on each of the leading edge surfaces 818. Of course, any geometric configuration can be used. The raised bars may be placed anywhere along one of the side rails 810, 812. For example, in some configurations of a slider there is no recess 822 along the length of the rail 810, 812, and a bar could be placed across that portion of the rail. The raised bars 890, 892 are made of DLC or another durable material. Of course, the features of the slider 800 are formed by depositing various materials onto a ceramic substrate and then mask and etch until the various features are formed. The bars are made of DLC placed atop the ceramic block, such as AlTiC, which is used to form the main body of the slider.

The DLC is precisely placed with respect to the trailing edge but does not have to be precisely placed with respect to the side rails. As a result, the bars can be quickly placed with a mask that is somewhat less than accurate with respect to the transverse rail direction. The DLC only has to be of a dimension so that after placing the step level mask and etching away certain portions of the slider, the DLC is still positioned to form a raised bar across the side rail. Typically, the DLC is placed onto the surface of the substrate using a mask. After depositing the DLC, the mask is removed and another step level mask is put in place and exposed to remove portions of the mask so that etching of the step level and cavity level can be accomplished. Of course, the deeper etchings require longer exposure times to ion mills so after the step level is formed, the step levels are masked and ion milling is continued to form the cavity. Most of the caps of DLC are laid down in an area which can accommodate the tolerances of the step mask. The cap is formed by precisely etching the substrate of the ceramic substrate which forms the slider end product.

Raised bars, such as 290, 890 and 892, are all formed generally of wear material such as diamond-like carbon. These bars are also manufacturable or easy to manufacture since they can be laid down with a less than accurate machine. The accuracy occurs when the step level mask is used and material is etched away. The slider is formed from a block of ceramic material which is etched away to form the various features on the air-bearing surface. In terms of making a bar 290, 890 or 892, the block or the slider surface which will eventually turn into the air-bearing surface can be either covered entirely with diamond-like carbon material or it can be masked and diamond-like carbon material can be placed in the general vicinity of the raised bar 890, 892, 290. The reason that the horizontal bar is more manufacturable is that because diamond-like carbon does not have to be placed precisely on what will turn into the air-bearing surface as an initial step.

As mentioned previously, successive masks are put in place and removed to produce various features on the air-bearing surface of the slider. A first mask is for features on the air-bearing surfaces. The second mask or shelf level mask is for all other features. After the shelf level features are formed, some may be masked to provide a protective layer while the cavity is formed. These masks, for example, can protect certain areas, such as the top of the bar, from ever being exposed to etching or removal of material of the block to produce the air-bearing surface.

The same holds true for raised pads 310, 510, 610, 810, 910, 1010 and 1110. The pads must be very precisely placed during the time when material is going to be removed from the surface of a ceramic block to form an air-bearing surface. However, the diamond-like carbon layer that typically covers the pads can be placed with loose tolerances so that another data may be selected for placement of the pads or pedestals.

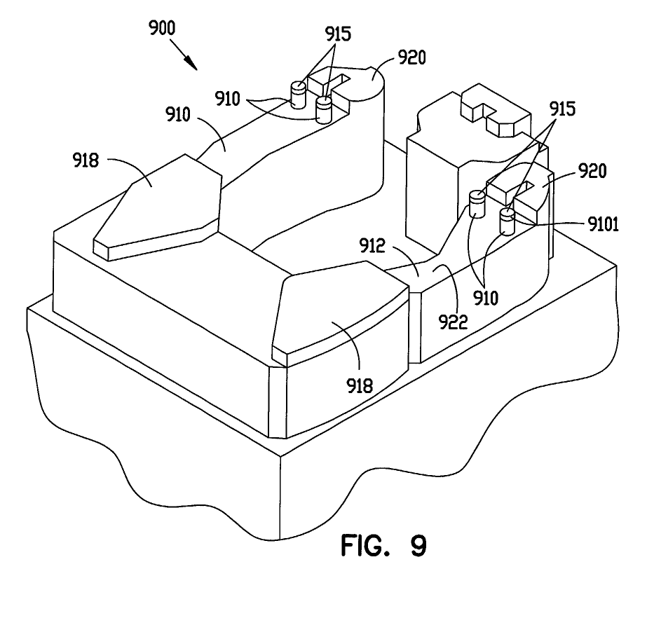

FIG. 9 shows another embodiment of a slider 900. In this particular case, the slider 900 is very similar to the slider 300 shown in FIG. 3. The differences between the slider 300 and the slider 900 will be highlighted rather than setting forth an entire new description. The basic difference between the slider 900 and the slider 300 is the elimination of the raised pads 293 on the leading edge surface 318. The leading edge surface can be left avoid of raised features or can include a raised bar or can be roughened by other means so as to reduce stiction if the slider 900 is to be used in a contact start stop disc drive.

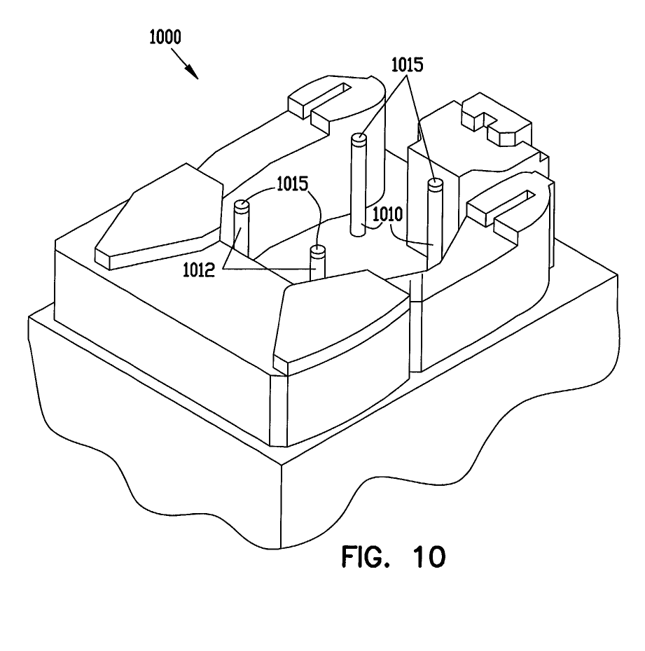

FIG. 10 shows yet another embodiment of slider 1000. The slider 1000 differs from the slider 500 shown in FIG. 5 in that two additional pedestals or elongated raised pads 1012 are positioned in the sub-ambient cavity and yet closer to the cavity and the leading edge of the slider. Of course, it should be noted that the pedestals or elongated raised pads 1010 and 1012 are all capped with DLC. Furthermore, it should be noted that although four pedestals or elongated pads 1010, 1012 are shown in FIG. 10, that there could be more or less pads formed that will prevent or reduce stiction between the slider 1000 and the disc surface 135.

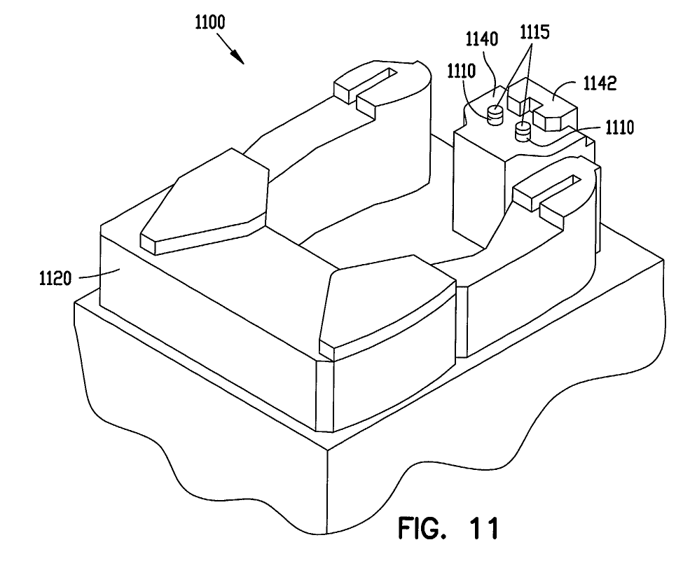

FIG. 11 shows another embodiment of a slider 1100. The slider 1100 is very close to the slider 600 shown in FIG. 6. The center rail 1140 includes a trench 1142. The surface of the center pad includes a pair of raised pads 1110. The raised pads 1110 are forward of the trench in that they are toward the leading edge 1120 of the slider 1100. It should be noted that the slider 1100, as shown, includes two of these pads 1110, but that the slider may include a different number of pads including a single pad 1110 or a plurality of pads beyond the two shown.

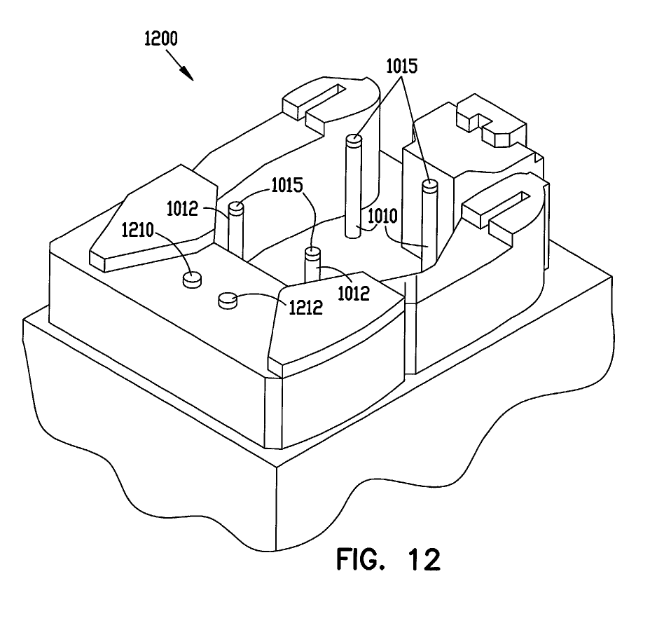

FIG. 12 shows another embodiment of a slider 1200. The slider 1200 is very close or differs only slightly from the slider 1000 shown in FIG. 10. In FIG. 12, the slider 1200 includes a set of raised pads 1210 and 1212 which are on the step surface toward the leading edge of the slider or which are positioned on the cavity dam of the slider. The raised pads 1210, 1212 are capped with a durable or a long-wearing material such as DLC. In this particular slider, step level features 1210 and 1212 are combined with the four elongated pedestals 1010 and 1012. Each of the raised features shown and described 1010 and 1012,1210 and 1212, are capped with DLC 1015. Of course, other geometric patterns could be formed and more or less of the pedestals or raised pads could be used in this invention and are considered within the scope of this invention shown in FIG. 12.

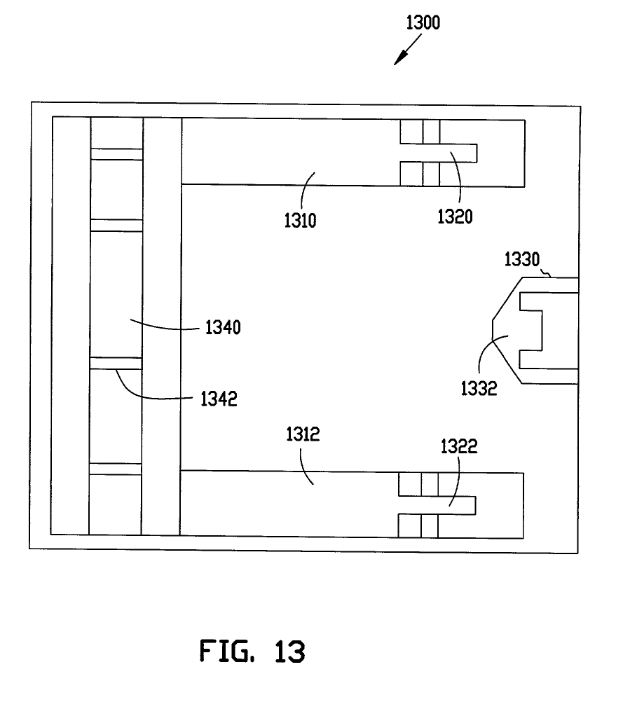

FIG. 13 shows an embodiment of a slider 1300 which is symmetrical and includes two side rails 1310, 1312 with trenches 1320, 1322 and a center rail 1330 with a trench 1332. This particular slider 1300 also includes a relatively thin cavity dam portion. The relatively thin dimension of the cavity dam may make it nearly impossible to place raised features on the cavity dam and, therefore, raised bars 1392 are placed across or transverse the cavity dam. In other words, the raised bars 1392 are dimensioned so that their long dimension roughly parallels the slide rail 1310, 1312 of the slider 1300. Of course, bars 1392 positioned across the cavity dam could also be combined with other raised features on the cavity dam.

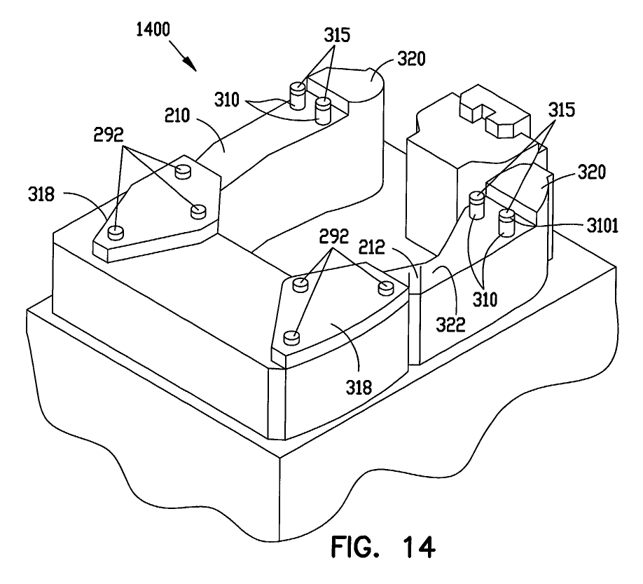

FIG. 14 is a perspective view of another embodiment of a slider 1400 according to the teachings of this invention. The slider 1400 is very similar to the slider 300 of FIG. 3. Slider 1400 differs from slider 300 in that the trailing air bearing surface 320 in that the trench in the trailing air bearing surface 320 has been removed in the slider 1400. The remaining elements are essentially the same as indicated by the identical reference numbers. It should be noted that the various pads described in each of the embodiments previously described are equally effective in the absence of trenches. In other words, the pads are equally effective in air bearing designs with out trenches as air bearing designs with trenches.

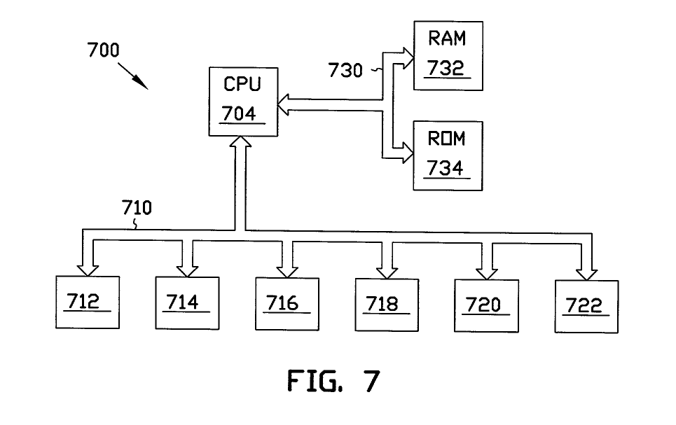

FIG. 7 is a schematic view of a computer system. Advantageously, the invention is well suited for use in a computer system 700 and more specifically for use in a peripheral such as a disc drive. The computer system 700 may also be called an electronic system or an information handling system and includes a central processing unit, a memory and a system bus. The information handling system includes a central processing unit 704, a random access memory 732, and a system bus 730 for communicatively coupling the central processing unit 704 and the random access memory 732. The information handling system 702 may also include an input/output bus 710 and several peripheral devices, such as 712, 714, 716, 718, 720, and 722 may be attached to the input output bus 710. Peripheral devices may include hard disc drives, magneto-optical drives, floppy disc drives, monitors, keyboards and other such peripherals. Any type of disc drive may include any of the sliders described herein.

### Conclusion

In conclusion, a slider 200 includes a cavity dam 230, a subambient pressure cavity 236, and first and second elongated rails 210 and 212. The subambient pressure cavity 236 trails the cavity dam 230 and has a cavity floor. The first and second rails 210 and 212 are disposed about the subambient pressure cavity 236. Each of the rails 210 and 212 has a rail width measured from an inner rail edge 214 to an outer rail edge 216, a leading bearing surface 218, a trailing bearing surface 220, and a recessed area 222 extending between the leading and trailing bearing surfaces 218 and 220. The recessed area 222 is recessed from the bearing surfaces 218 and 220 and raised from the cavity floor, across the rail width. First and second convergent channels 260, 262 are recessed within the trailing bearing surfaces of the first and second rails 210 and 212, respectively. Each channel 260 and 262 has a leading channel end 266 open to fluid flow from the respective recessed area, non-divergent channel side walls 268, and a trailing channel end 270 closed to the fluid flow and forward of a localized region of the respective trailing bearing surface 220. Each of the channels 260 and 262 has a side wall 280 on either side of the leading channel ends 266. The slider 200 also includes a raised bar 290 protruding from each of the trailing bearing surfaces 220 of the first and second rails 210 and 212 such that the raise bar 290 is near the leading channel end 266. The raised bar 290 provides a separation between bearing surfaces 218 and 220 and a disc surface 135 when the head slider 200 is at rest on the disc surface 135. The at least one raised bar 290 protrudes from the trailing bearing surfaces 220 such that it has a reduced impact on the overall flying characteristics of the head slider 200 due to positional variations in the width direction of the raised bar 290 with respect to the trailing bearing surfaces 220. Further, the separation significantly reduces stiction forces between the head slider 200 and the disc surface 134.

Another aspect of the present invention relates to a disc slider 200, which includes a leading slider edge 201, a trailing slider edge 202, a cavity dam 230, and a subambient pressure cavity 236. The subambient pressure cavity 236 trails the cavity dam 230 and has a cavity floor. The first and second rails 210 and 212 are disposed about the subambient pressure cavity 236. Each of the rails 210 and 212 has a rail width measured from an inner rail edge 214 to an outer rail edge 216, a leading bearing surface 218, a trailing bearing surface 220, and a recessed area 222 extending between leading and trailing bearing surfaces 218 and 220. The recessed area 222 is recessed from the bearing surfaces 218 and 220 and raised from the cavity floor, across the rail width. First and second convergent channels 260 and 262 are recessed within the trailing bearing surfaces 220 of the first and second rails 210 and 212, respectively. Each channel 260 and 262 has a leading channel end 266 open to fluid flow from the respective recessed area, non-divergent channel side walls 268 and a trailing channel end 270 closed to the fluid flow and forward of a localized region of the respective trailing bearing surface 220. The slider 200 further has at least one raised pad 292 protruding from each of the leading bearing surfaces 218 of the first and second rails 210 and 212. In some embodiments, the slider 300 also includes at least one raised pad 310 protruding from each of the recessed areas 222 of the first and second rails 210 and 212. The at least one raised pad 310 protruding from the recessed areas 222 provides a separation between the bearing surfaces 218 and 220 and a disc surface when the head slider 300 is at rest on the disc surface. The at least one raised pad 310 protrudes from the recessed areas 222 such that the protrusion reduces surface tension between a lubricant disposed on a disc surface 134. Also, the at least one raised pad 310 significantly reduces stiction forces between the head slider 300 and the disc surface 134. Further, the at least one raised pad 310 protrudes from the recessed areas 222 such that it has a reduced impact on the overall flying characteristics of the head slider 300 due to positional variations in the location of the raised pad 310 with respect to the recessed areas 222.

The head slider 200 further includes first and second convergent channels 260 and 262, which are recessed within the trailing bearing surfaces 220 of the first and second rails 210 and 212, respectively. Each of the first and second channels 260 and 262 has a leading channel 266 open to fluid flow from the respective recessed areas 222, non-divergent channel side walls 268, and a trailing channel end 270 closed to the fluid flow and forward of a localized region of the respective trailing bearing surface 220. Each of the first and second channels 260 and 262 further has a side wall 280 on either side of the leading channel ends 266.

The head slider 200 further includes a raised center rail 240 positioned along trailing slider edge 202 and between the first and second elongated raised side rails 210 and 212. The raised center rail 240 has a leading step surface 241. The leading step surface is substantially parallel to and recessed from a center rail bearing surface 242. The center rail bearing surface 242 is at a height similar to the height of the leading and trailing bearing surfaces 218 and 220.

Yet another aspect of the present invention relates to a disc drive assembly 100, which includes a housing 112, a disc 135, an actuator 120 and a slider 126. The disc 135 is rotatable about a central axis within the housing 112 and has a recording surface with a data area 134 and a landing area 111, which are non-textured. The actuator 120 is mounted within the housing 112. The slider 126 is supported over the recording surface 134 by the actuator 126 and includes a cavity dam 230, a subambient pressure cavity 236 and first and second elongated rails 210 and 212. The subambient pressure cavity 236 trails the cavity dam 230 and has a cavity floor. The first and second rails 210 and 212 are disposed about the subambient pressure cavity 236. Each of the rails 210 and 212 has a rail width measured from an inner rail edge 214 to an outer rail edge 216, a leading bearing surface 218, a trailing bearing surface 220, and a recessed area 222 extending between the leading and trailing bearing surfaces 218 and 220. The recessed area 222 is recessed from the bearing surfaces 218 and 220 and raised from the cavity floor, across the rail width. The slider 126 further includes at least one raised pad 310 protruding from each of the recessed areas 222 of the first and second rails 210 and 212. The at least one raised pad 310 provides a separation between the bearing surfaces 218 and 220 and a disc surface 134 when head slider 126 is at rest on disc surface 134. The at least one raised pad 310 protrudes from the recessed areas 222 such that the protrusion reduces surface tension between a lubricant disposed on a disc surface 134. Also, the at least one raised pad 310 significantly reduces stiction forces between the head slider 300 and the disc surface 134. Further, the at least one raised pad 310 protrudes from the recessed areas 222 such that it has a reduced impact on the overall flying characteristics of the head slider 300 due to positional variations in the location of the raised pad 310 with respect to the recessed areas 222. The slider 126 further includes at least one raised pad 510 in the subambient pressure cavity 236.

First and second convergent channels 260 and 262 are recessed within the trailing bearing surfaces 220 of the first and second rails 210 and 212, respectively. Each channel 260 and 262 has a leading channel end 266 open to fluid flow from the respective recessed area 222, non-divergent channel side walls 280 and a trailing channel end 270 closed to the fluid flow and forward of a localized region of the respective trailing bearing surface 220. A raised center rail 240 is positioned along trailing slider edge 202 and between the first and second elongated raised side rails 210 and 212. The raised center rail 240 has a leading step surface 241. The leading step surface 241 is substantially parallel to and recessed from a center rail bearing surface 242. The center rail bearing surface 242 is at a height similar to the height of the leading and trailing bearing surfaces 218 and 220. It is to be understood that the above description is intended to be illustrative, and not restrictive. Many other embodiments will be apparent to those of skill in the art upon reviewing the above description. The scope of the invention should, therefore, be determined with reference to the appended claims, along with the full scope of equivalents to which such claims are entitled.

What is claimed is:

1. A slider for a disc drive comprising:
a leading edge;
a trailing edge;
a pair of side edges;
a first side rail extending along one of the side edges between the leading edge and the trailing edge;
a second side rail extending along the other of the side edges between the leading edge and the trailing edge; and
a raised feature substantially traversing the side rail.

2. The slider of claim 1 wherein each of the first side rail and the second side rail has a recess therein between the portion of the side rail near the leading edge and the portion of the side rail near the trailing edge, the recess forming a leading edge bearing surface and a trailing edge bearing surface on each of the first and second side rails, wherein the raised feature traverses the trailing edge bearing surface of each of the first and second side rails.

3. The slider of claim 2 further comprising a third and fourth raised feature which traverse the leading edge bearing surface of the first side rail and the leading edge bearing surface of the second side rail.

4. The slider of claim 1, wherein the raised feature is a bar.

5. The slider of claim 4, wherein the bar has a width in the range of about 5 micrometers to 100 micrometers.

6. The slider of claim 1 wherein the raised feature includes a a cap of material having a hardness which is greater than the hardness of the material forming the majority of the slider.

7. The slider of claim 1 wherein the raised feature comprises diamond like carbon.

8. The slider of claim 1 further including a cavity dam which is positioned on the air-bearing surface near the leading edge of the slider, the cavity dam connecting the first rail and the second rail and defining a cavity bounded by the first rail, the second rail and the cavity dam, the cavity having a floor, the slider further including a pedestal having a connected end attached to the floor of the cavity and a free end, and having a pad attached to the free end of the pedestal.

9. The slider of claim 8 wherein the pad of the pedestal further comprises diamond like carbon.

10. The slider of claim 1 further including a center bearing surface on the air-bearing surface, the center bearing surface positioned near the trailing edge, the center bearing surface also including a raised pad on the step surface near the center bearing surface.

11. The slider of claim 2 further comprising at least one raised pad on each of the leading edge bearing surface of the first side rail and the leading edge bearing surface of the second side rail.

12. The slider of claim 2 further comprising a plurality of raised pads on each of the leading edge bearing surface of the first side rail and the leading edge bearing surface of the second side rail.

13. The slider of claim 2 further comprising at least one raised pad attached to the recessed portion of the first side rail and the recessed portion of the second side rail.

14. The slider of claim 2 further comprising a plurality of raised pads attached to the recessed portion of the first side rail and to the recessed portion of the second side rail.

15. The slider of claim 14 wherein each of the raised pads attached to the recessed portion of the first side rail and the second side rail are comprised of diamond like carbon.

16. The head slider of claim 14, wherein the pads extending from the recessed areas in the range of about 10 nanometers to 30 nanometers.

17. A disc drive assembly, comprising:
a housing;
a disc rotatable about a central axis within the housing, wherein the disc comprises a recording surface with a data area and a landing area, which are non-textured;
an actuator mounted within the housing; and
a slider supported over the recording surface by the actuator, the slider further comprising:
a leading edge;
a trailing edge;
a first side rail positioned near one side edge of the slider;
a second side rail positioned near the other side edge of the slider;
a cavity dam connecting the first and second rails and positioned near the leading edge of the slider; and
a center air-bearing surface positioned near the trailing edge of the slider, the center air-bearing surface including:
a trench;
a raised center bearing surface pad positioned between the trench and the leading edge of the slider.

18. The disc drive of claim 17 further comprising a plurality of raised pads positioned near the center bearing surface and between the trench and the leading edge of the slider.

19. The disc drive of claim 17 wherein the raised pad near the center bearing surface is positioned between the trench and the leading edge of the slider and includes a material which is harder than the material comprising the majority of the slider.

20. A disc drive comprising:
a housing;
a disc rotatably attached to the housing;
a slider; and
an actuator mounted within the housing which is adapted to move the slider to various positions on the disc, the slider including means for reducing stiction between the slider and the disc.
